(19) United States
(12) Patent Application Publication
(10) Pub. No.: US 2020/0091860 A1
(43) Pub. Date: Mar. 19, 2020

(54) SOLAR PHOTOVOLTAIC MODULE

(71) Applicant: LSIS CO., LTD., Anyang-si, Gyeonggi-do (KR)

(72) Inventors: Boram KANG, Anyang-si, Gyeonggi-do (KR); Changsub WON, Anyang-si, Gyeonggi-do (KR); Dongchan KIM, Anyang-si, Gyeonggi-do (KR); Kwangwook KIM, Anyang-si, Gyeonggi-do (KR); Waithiru LAWRENCE, Anyang-si, Gyeonggi-do (KR); Gunhyun LEE, Anyang-si, Gyeonggi-do (KR)

(21) Appl. No.: 16/494,628

(22) PCT Filed: Aug. 7, 2017
(86) PCT No.: PCT/KR2017/008517

§ 371 Date: Sep. 16, 2019

(30) Foreign Application Priority Data
Mar. 17, 2017 (KR) 10-2017-0034036

(51) Int. Cl. H02S 30/00; H02S 20/30

(52) U.S. Cl. CPC H02S 30/00; H02S 20/30

(57) ABSTRACT

The present invention relates to a solar photovoltaic module and, more specifically, to a solar photovoltaic module having an angle adjustment function. A solar photovoltaic module according to an embodiment of the present invention, which is configured by a plurality of solar cells for absorbing sunlight to generate electric current and generates electric power, comprises: a coupling protrusion formed on one side or both sides of the solar photovoltaic module; a support coupled to the coupling protrusion to be three-dimensionally rotatable; a wire connected to an upper part of the support; and a weight provided at a lower part of the support.

### TECHNICAL FIELD

The present disclosure relates to a solar photovoltaic module, and more particularly, to a solar photovoltaic module equipped with a bird deterrent system having an angle adjustment function.

### BACKGROUND ART

In general, a solar photovoltaic device (or system) is designed to convert sunlight into electrical energy using a solar cell. The photovoltaic device is usually manufactured in the form of a module. As for the solar photovoltaic module, solar cells are connected in series with a ribbon wire, pressed together with glass and encapsulant at high temperature/high pressure, and connected to a frame.

Power generation efficiency of the solar photovoltaic device is determined by the amount of sunlight (irradiance). Accordingly, a large area with a plentiful amount of sunlight is required to increase the power generation efficiency. In case of installing a photovoltaic device on land, its practical application may be difficult due to some issues regarding hard civil engineering works such as installation site selection, soil preparation, and the like. Thus, a floating solar photovoltaic device has been actively adopted as an alternative to it.

In such a floating solar photovoltaic device, a panel of a solar photovoltaic module should be kept clean in order to prevent a decrease in power generation efficiency. As solar cells are exposed to outside the solar photovoltaic module, an output (power) of a solar photovoltaic module system is significantly reduced when the solar cells are shaded by external environmental factors. In a structure where the solar cells are connected in series, if dust or a contaminant is accumulated on a (specific) solar cell, a temperature of the shaded solar cell rises, which causes an output loss of more than one solar cell string (solar cells connected in series). This phenomenon is called hot-spots (or hot spot heating). In addition, the output of the solar photovoltaic module and durability of the solar photovoltaic module can be decreased by bird droppings.

FIG. 1 is a perspective view of a solar photovoltaic module according to the related art. In the related art photovoltaic module 1, solar cells 2 are connected in series and in parallel to press encapsulants of front and rear surfaces and glass via a high-temperature and high-pressure lamination process, and are then connected by a frame. The solar photovoltaic module 1 generates an electric current using solar energy obtained from the solar cells 2, and the electric current flows through a wire connected to the solar photovoltaic module 1 to generate electricity.

If dust or a contaminant is accumulated on a (specific) solar cell 2, radiant light from the sun cannot be directly received. Accordingly, an electric current flow in an area where the shaded solar cell 2 is located is cut off, and the electric current flows only in the remaining solar cells 2. Local overheating may also occur. In addition, an aluminum frame of the solar photovoltaic module 1 can be corroded by birds and bird droppings, which greatly affects durability of the solar photovoltaic module 1.

Thus, a bird deterrent system is provided to keep birds away. In the related art solar photovoltaic module, fixing bars 3 are provided on both sides of the frame of the solar photovoltaic module 1, and a wire 4 is provided between the fixing bars 3 to keep the birds away.

However, since a fixed-type wire is used in the related art bird deterrent system, the effect is not great. In addition, as the wire is installed above a surface of the solar photovoltaic module 1, shadows of the fixing bar 3 and the wire 4 can be casted on the solar photovoltaic module 1 according to a position of the sun. This may lead to a decrease in efficiency of the solar photovoltaic module 1.

### DISCLOSURE

### Technical Problem

The present disclosure is directed to solving the above-mentioned problems and other drawbacks. Therefore, an aspect of the present disclosure is to provide a solar photovoltaic module equipped with a bird deterrent system having an angle adjustment function.

### Technical Solution

In order to achieve the aspect and other advantages, there is provided a solar photovoltaic module having multiple solar cells for generating electricity by absorbing sunlight to generate an electric current. The solar photovoltaic module according to one embodiment of the present disclosure includes a coupling protrusion formed on one side or both sides of the solar photovoltaic module, a support coupled to the coupling protrusion to be three-dimensionally rotatable, a wire connected to an upper part of the support, and a ballast provided at a lower part of the support.

Here, a plurality of connecting members coupled to the upper part of the support may be further provided.

In addition, the coupling protrusion may be formed in a spherical shape.

Further, a neck may be provided between the coupling protrusion and the solar photovoltaic module. The neck may be formed to have a diameter smaller than a diameter of the coupling protrusion.

Also, the lower part of the support may be provided with a coupling groove to which the coupling protrusion is insertedly coupled.

The coupling groove may be formed in a cylinder shape so that the coupling protrusion is movable.

Further, the coupling groove may include an inlet having an insertion portion in which the coupling protrusion is inserted, and a coupling portion formed on an upper side of the insertion portion, and having a diameter smaller than a diameter of the insertion portion and larger than the diameter of the neck.

The lower part of the support may be provided with a housing for accommodating the ballast.

Further, the housing may be provided with a horizontal adjuster and a vertical adjuster for adjusting a position of the ballast.

The side surfaces of the housing may be provided with a horizontal adjustment groove and a vertical adjustment groove in which the horizontal adjuster and the vertical adjuster are inserted, respectively.

In addition, the side surfaces of the housing are provided with a plurality of fixing grooves to which the horizontal adjuster and the vertical adjuster are fixed.

Further, the housing may be provided therein with a driving motor configured to move the horizontal adjuster and the vertical adjuster.

In addition, a controller configured to control movement of the driving motor may be further provided.

Further, the support may be detachably coupled to the coupling protrusion.

### Advantageous Effects

In a solar photovoltaic module according to one embodiment of the present disclosure, a support is maintained perpendicular to a surface of water (still water surface) by a ballast. Thus, the support can be maintained its vertical position even when the solar photovoltaic module is shaken due to angle changes of the solar photovoltaic module, or by the wind or the waves.

In addition, an angle of the support can be adjusted by adjusting a position of the ballast, thereby properly coping with angle changes of the solar photovoltaic module or solar altitude variations.

### BRIEF DESCRIPTION OF THE DRAWINGS

FIG. 1 is a perspective view of a solar photovoltaic module according to the related art.

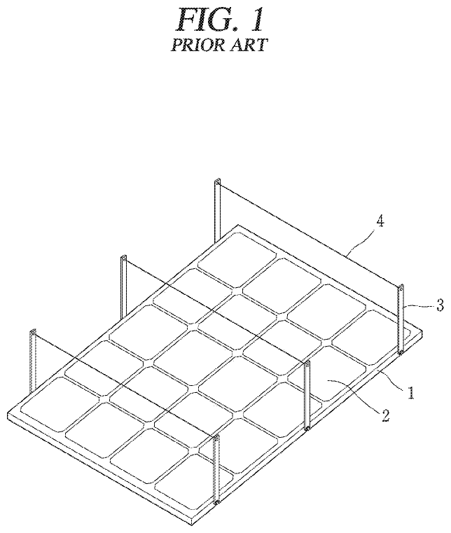

FIG. 2 is a perspective view of a solar photovoltaic module according to one embodiment of the present disclosure.

FIG. 3 is a disassembled perspective view illustrating a support and a connecting member of FIG. 2.

FIG. 4 is a partial sectional view of the support of FIG. 3.

FIG. 5 is a partial perspective view of the support of FIG. 2. Here, an angle adjustment housing is only illustrated.

FIG. 6 is a view illustrating an operation of a solar photovoltaic module according to one embodiment of the present disclosure.

FIG. 7 is another embodiment of a support applied to a solar photovoltaic module according to the present disclosure.

FIG. 8 is another embodiment of an angle adjustment housing applied to a solar photovoltaic module according to the present disclosure.

FIG. 9 is still another embodiment of a support applied to a solar photovoltaic module according to the present disclosure.

### MODE FOR CARRYING OUT THE PREFERRED EMBODIMENTS

Hereinafter, preferred embodiments of the present disclosure will be described with reference to the accompanying drawings, so that a person skilled in the art can easily carry out the invention. It should be understood that the technical idea and scope of the present invention are not limited to those preferred embodiments.

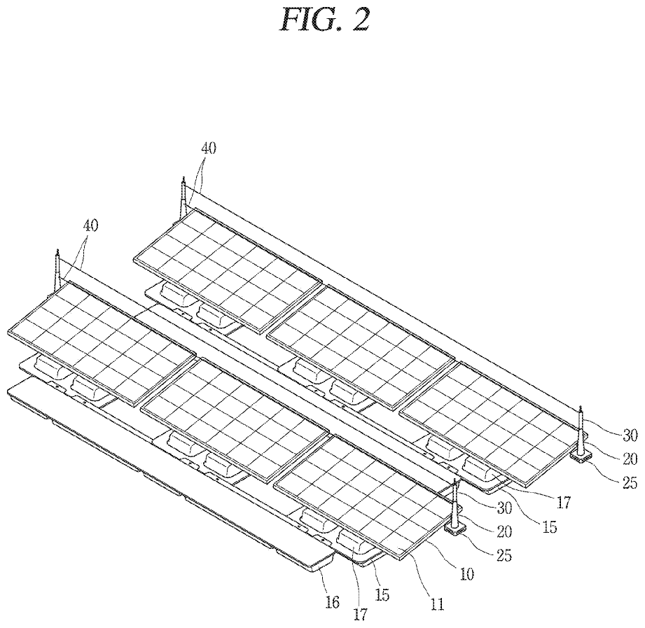

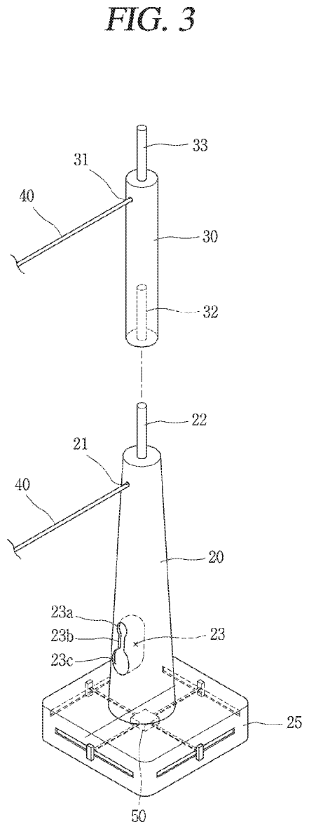

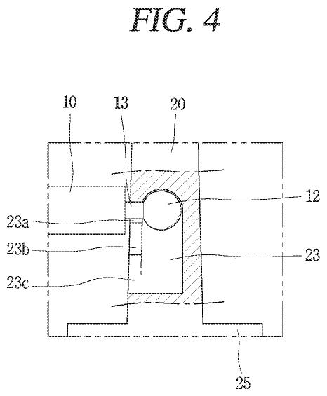

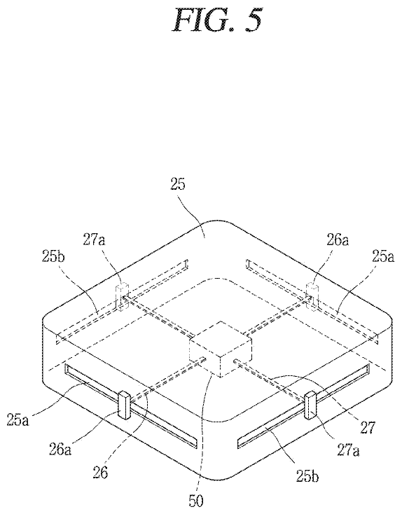

FIG. 2 is a perspective view of a solar photovoltaic module according to one embodiment of the present disclosure, FIG. 3 is a disassembled perspective view illustrating a support and a connecting member of FIG. 2, FIG. 4 is a partial sectional view of the support of FIG. 3, and FIG. 5 is a partial perspective view of the support of FIG. 2. A solar photovoltaic module according to each embodiment of the present disclosure will be described in detail with reference to the drawings.

In a solar photovoltaic module 10 according to one embodiment of the present disclosure having multiple solar cells 11 for generating electricity (electric power) by absorbing sunlight to generate an electric current, the solar photovoltaic module 10 includes a coupling protrusion 12 formed on one side or both sides of the solar photovoltaic module 10, a support 20 coupled to the coupling protrusion 12 to be three-dimensionally rotatable, a wire 40 connected to an upper part of the support 20, and a ballast (weight) 50 provided at a lower part of the support 20.

In a frame the solar photovoltaic module 10, the multiple solar cells 11 are connected in series and in parallel. The solar photovoltaic module 10 generates an electric current using solar energy obtained from the solar cells 11, and this electric current flows through an electric wire connected to the solar photovoltaic module 10, generating electricity.

A plurality of solar photovoltaic modules 10 is installed side by side in series or in parallel to form a group. A supporter 15 having buoyancy is provided for supporting the plurality of solar photovoltaic modules 10 installed on a body of water. In this case, the solar photovoltaic modules 10 need be disposed away from the surface of water at a predetermined distance. Accordingly, the support 15 should be installed to float above the surface of water with sufficient buoyancy, and some of the supporters are provided with a mounting portion 17 formed in a protruding manner so as to install the solar photovoltaic module 10.

In addition, a connecting part 16 may be provided between each of the supporters 15 to form a passage for maintenance and repairs.

The coupling protrusion 12 is formed on one side or both sides of the frame of the solar photovoltaic module 10. The coupling protrusion 12 may be formed in a spherical shape. A neck 13 may be formed between the coupling protrusion 12 and the frame of the solar photovoltaic module 10. It is preferable that a diameter of the neck 13 is smaller than a diameter of the coupling protrusion 12.

The support 20 is installed on the frame forming an outer appearance (exterior) of the solar photovoltaic module 10. The support 20 may be installed at outer ends of the frame of the photovoltaic modules 10 installed at both ends of each row of the solar photovoltaic modules 10 in a group. In more detail, the support 20 may be installed at a right end of the solar photovoltaic module 10 installed at the rightmost end and a left end installed at the leftmost end of the solar photovoltaic module 10, respectively, in the drawing. However, depending on the purpose of use or the surrounding environment, the support 20 may be installed for each solar photovoltaic module 10 or may be installed for each unit classified into plural solar photovoltaic modules 10. A lower end of the support 20 is installed on the frame of the solar photovoltaic module 10.

The support 20 may be configured as a plate, a bar, or a rod. The support 20 may be formed in a cone shape. That is, a diameter of the upper part of the support 20 may be formed to be smaller than a diameter of the lower part of the support 20. Thus, the entire weight of the support is concentrated downward.

A wire hole 21 into which the wire 40 is inserted is formed in the upper part of the support 20. The wire 40 is insertedly coupled to the wire hole 21.

A connecting protrusion 22 to which a connecting member 30 is coupled may be provided at an upper end of the support 20 in a protruding manner.

A coupling groove 23 in which the coupling protrusion 12 of the solar photovoltaic module 10 is inserted is formed on the lower part of the support 20. The coupling groove 23 may be formed in a cylindrical shape in which the coupling protrusion 12 can slide. Inlet portions 23a, 23b, and 23c of the coupling groove 23 may be formed in a shape of gourd or snowman. In more detail, the inlet portions 23a, 23b, and 23c of the coupling groove 23 may be configured as the coupling portion 23a formed at an upper part of the inlet, the connecting portion 23b formed at an intermediate part thereof, and the insertion portion 23c formed at a lower part thereof. Here, a diameter of each portion is preferably formed in the order of the connecting portion 23b <the coupling portion 23a< the insertion portion 23c.

The inlet portions 23a, 23b and 23c of the coupling groove 23 are for assembling or disassembling the coupling protrusion 12 to or from the support 20. The coupling protrusion 12 is inserted into the coupling groove 23 through the insertion portion 23c of the coupling groove 23, is moved upward through the connecting portion 23b, and is then installed to the coupling portion 23a. Here, the diameter of the connecting portion 23b may be slightly smaller than the diameter of the neck 13 of the coupling protrusion 12. This is to insert the coupling protrusion 12 into the connecting portion 23b in an interference fit manner. Thus, the coupling protrusion 12 may not be detached or displaced after being coupled to the coupling portion 23a.

Specifically, the coupling protrusion 12 is disposed on an upper part of the coupling groove 23, and the neck 13 is placed on the coupling portion 23a of the inlet. An upper surface of the coupling groove 23 is formed in a spherical shape in a manner of enclosing the coupling protrusion 12, which enables the coupling protrusion 12 to be three-dimensionally rotated in the coupling groove 23. In other words, the support 20 can be three-dimensionally rotated with respect to the coupling protrusion 12.

The connecting member 30 may be provided on the upper part of the support 20. A second wire hole 31 is formed on an upper part of the connecting member 30. An insertion groove 32 is provided on a lower end of the connecting member 30 so as to be fitted into the connecting protrusion 22 of the support 20. A second connecting protrusion 33 like the connecting protrusion 22 is provided on an upper end of the connecting member 30. Accordingly, a plurality of connecting members 30 can be consecutively arranged in series.

The wire 40 may be inserted into the wire hole 21 and the second wire hole 31. An end of the wire 40 may be fixed to an outer surface of the support 20. The wire 40 may be made of an elastic material. In addition, the wire 40 may be formed of a conductive material to make an electric current flow through it.

The electric current flowing in the wire 40 can be supplied from electricity generated in the solar photovoltaic module 10.

A ballast 50 is provided on the lower end of the support 20. The ballast 50 is made of a heavy-weight material so that the support 20 is stably balanced without shaking. The support 20 is maintained its vertical direction by the weight of the ballast 50 unless an additional external force is applied.

A housing 25 capable of accommodating the ballast 50 may be provided at the lower end of the support 20. Here, the interior of the housing 25 may form an empty space in which the ballast 50 is moveable.

The housing 25 may be provided with a parallel moving device for moving the ballast 50 in parallel. Here, the parallel moving device may also be referred to as an angle adjustment device because it serves to adjust an angle of the support 20.

The parallel moving device (angle adjustment device) may include a horizontal adjuster 26 and a vertical adjuster 27 provided in the housing 25. On the side surfaces of the housing 25, a horizontal adjustment groove 25a may be formed on front and rear surfaces of the housing 25, respectively, along the lengthwise direction, and a vertical adjustment groove 25b may be formed on left and right surfaces thereof, respectively, along the lengthwise direction. Here, it is preferable that a distance from the bottom of the housing 25 to the horizontal adjustment groove 25a, and a distance from the bottom of the housing 25 to the vertical adjustment groove 25b are set to be different from each other.

The horizontal adjuster 26 may be provided to penetrate the ballast 50 in a front-to-rear direction. The horizontal adjuster 26 can move from left to right along the horizontal adjustment groove 25a. As the horizontal adjuster 26 moves, the ballast 50 moves from left to right within the housing 25. In order to fix the horizontal adjuster 26, horizontal fixing portions 26a are provided at both ends thereof. The horizontal fixing portions 26a at the both ends of the horizontal adjuster 26 are hung on the front and rear surfaces of the housing 25 to fix the horizontal adjuster 26.

The vertical adjuster 27 may be provided to penetrate the ballast 50 in a left-to-right direction. The vertical adjuster 27 can move back and forth along the vertical adjustment groove 25b. As the vertical adjuster 27 moves, the ballast 50 moves back and forth within the housing 25. In order to fix the vertical adjuster 27, vertical fixing portions 27a are provided at both ends thereof. The vertical fixing portions 27a at the both ends of the vertical adjuster 27 are hung on the left and right surfaces of the housing 25 to fix the vertical adjuster 27.

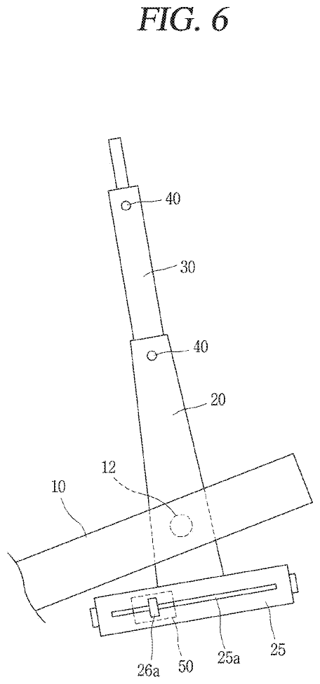

FIG. 6 is a view illustrating an operation of a solar photovoltaic module according to one embodiment of the present disclosure, viewed from a side direction. In FIG. 6. the ballast 50 is moved forward by moving the vertical adjuster 27 forward. As the ballast 50 moves forward, the support 20 rotates with respect to the coupling protrusion 12 so that an upper end portion thereof is tilted (or leaned) forward. The wire 40 is placed right above the solar photovoltaic module 10. This inclination can be set according to an angle between the sun and the solar photovoltaic module 10. This angle can also be set in consideration of seasonal solar altitude variations.

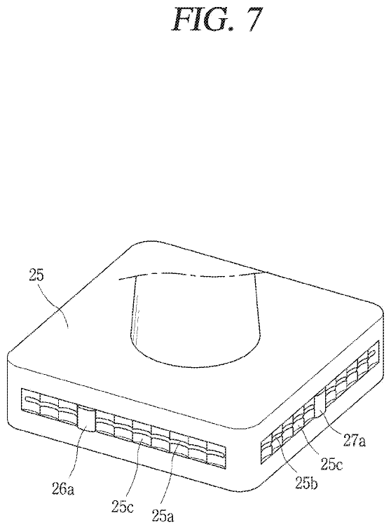

Another embodiment will be described with reference to FIG. 7. In FIG. 7, another embodiment of a support applied to the solar photovoltaic module according to the present disclosure is illustrated. In this embodiment, the housing 25 is provided with a plurality of fixing grooves 25c for fixing the horizontal fixing portions 26a or the vertical fixing portions 27a in the vicinity of the horizontal adjustment groove 25a or the vertical adjustment groove 25b. The fixing groove 25c may be formed closely with each other to serve as marks (or graduations) for adjustment. That is, the fixing grove 25c may help to set moving displacements of the horizontal adjuster 26 and the vertical adjuster 27.

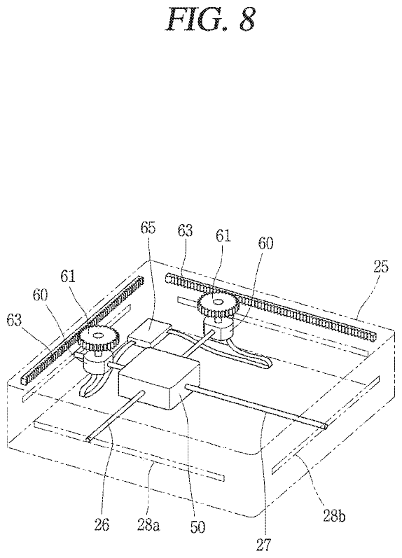

Another embodiment will be described with reference to FIG. 8. In FIG. 8, another embodiment of an angle adjustment housing applied to the solar photovoltaic module according to the present disclosure is illustrated. The horizontal adjuster 26 and the vertical adjuster 27 may be moved by a driving motor 60. The driving motor 60 for moving the horizontal adjuster 26 and the vertical adjuster 27 is provided in the housing 25, respectively. Each of the driving motor 60 may be provided at one end portion of the horizontal adjuster 26 and the vertical adjuster 27, respectively. A rack 63 is formed on an inner surface of the housing 25 so as to be engaged with a toothed gear 61 of the drive motor 60. That is, as the driving motor 60 driven by a rack-and-pinion mechanism moves, the horizontal adjuster 26 and the vertical adjuster 27 move the ballast 50 while moving together. In this embodiment, a horizontal adjustment groove 28a and a vertical adjustment groove 28b may be formed on the inner surface of the housing 25.

A controller 65 may be provided inside or outside the housing 25.

The controller 65 may turn on/off the driving motor 60 or adjust rotation of the driving motor 60. The controller 65 may control the driving motor 60 to rotate forward or reversely. The controller 65 may control moving displacements of the horizontal adjuster 26 and the vertical adjuster 27. Such moving displacements may be set according to the angle between the sun and the solar photovoltaic module 10. This angle can also be set in consideration of seasonal solar altitude variations.

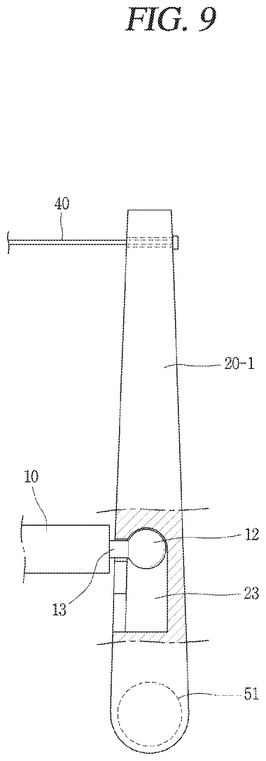

FIG. 9 illustrates a support according to another embodiment of the present disclosure. In this embodiment, a ballast 51 is provided at a lower end portion of a support 20-1. The support 20-1 according to this embodiment is not equipped with a parallel moving device for artificially adjusting a position of the ballast 51. However, the ballast 51 has an automatic balancing function, which maintains the support 20-1 positioned perpendicular to the surface of water even when the solar module 10 is shaken.

In the solar photovoltaic module according to one embodiment of the present disclosure, a support is maintained perpendicular to the surface of water (still water surface) by a ballast. Thus, the support can be maintained its vertical position even when the solar photovoltaic module is shaken due to angle changes of the solar photovoltaic module, or by the wind or the waves.

In addition, an angle of the support can be adjusted by adjusting a position of the ballast, thereby properly coping with angle changes of the solar photovoltaic module or solar altitude variations.

While the invention has been shown and described with reference to the foregoing preferred embodiments thereof, it will be understood by those skilled in the art that various changes and modifications may be made without departing from the spirit and scope of the invention as defined by the appended claims. Therefore, the embodiments disclosed in the present invention are not intended to limit the scope of the present invention but are merely illustrative, and it should be understood that the scope of the technical idea of the present invention is not limited by those embodiments. That is, the scope of protection of the present invention should be construed according to the appended claims, and all technical ideas within the scope of equivalents thereof should be construed as being included in the scope of the present invention.

1. A solar photovoltaic module consists of multiple solar cells for generating electricity by absorbing sunlight to generate an electric current, the solar photovoltaic module comprising:
a coupling protrusion formed on one side or both sides of the solar photovoltaic module;
a support coupled to the coupling protrusion to be three-dimensionally rotatable;
a wire connected to an upper part of the support; and
a ballast provided at a lower part of the support.

2. The solar photovoltaic module of claim 1, further comprising a plurality of connecting members coupled to the upper part of the support.

3. The solar photovoltaic module of claim 1, wherein the coupling protrusion is formed in a spherical shape.

4. The solar photovoltaic module of claim 1, wherein the coupling protrusion and the solar photovoltaic module are provided with a neck formed therebetween, and wherein the neck is formed to have a diameter smaller than a diameter of the coupling protrusion.

5. The solar photovoltaic module of claim 4, wherein the lower part of the support is provided with a coupling groove to which the coupling protrusion is insertedly coupled.

6. The solar photovoltaic module of claim 5, wherein the coupling groove is formed in a cylinder shape so that the coupling protrusion is movable.

7. The solar photovoltaic module of claim 5, wherein the coupling groove includes an inlet,
the inlet comprising:
an insertion portion in which the coupling protrusion is inserted; and
a coupling portion formed on an upper side of the insertion portion, and having a diameter smaller than a diameter of the insertion portion and larger than the diameter of the neck.

8. The solar photovoltaic module of claim 1, wherein the lower part of the support is provided with a housing for accommodating the ballast.

9. The solar photovoltaic module of claim 8, wherein the housing is provided with a horizontal adjuster and a vertical adjuster configured to adjust a position of the ballast.

10. The solar photovoltaic module of claim 9, wherein the side surfaces of the housing are provided with a horizontal adjustment groove and a vertical adjustment groove in which the horizontal adjuster and the vertical adjuster are inserted, respectively.

11. The solar photovoltaic module of claim 9, wherein the side surfaces of the housing are provided with a plurality of fixing grooves to which the horizontal adjuster and the vertical adjuster are fixed.

12. The solar photovoltaic module of claim 9, wherein the housing is provided therein with a driving motor configured to move the horizontal adjuster and the vertical adjuster.

13. The solar photovoltaic module of claim 12, further comprising a controller configured to control movement of the driving motor.

14. The solar photovoltaic module of claim 1, wherein the support is detachably coupled to the coupling protrusion.
